(19) United States
(12) Patent Application Publication
(10) Pub. No.: US 2025/0297666 A1
(43) Pub. Date: Sep. 25, 2025

(54) SEALING ASSEMBLY FOR A DAMPER, OR DAMPER INCLUDING IMPROVED SEALING ASSEMBLY

(71) Applicant: RB Distribution, Inc., Colmar, PA (US)

(72) Inventors: Tam Nguyen, Lincoln University, PA (US); Glenn Sincovich, Doylestown, PA (US); William Hunt, Wilmington, DE (US); Ethan DiBona, Glenside, PA (US); Cameron Medendorp, Telford, PA (US)

(21) Appl. No.: 18/612,635

(22) Filed: Mar. 21, 2024

(51) Int. Cl. F16F 9/516; F16F 9/53

(52) U.S. Cl. CPC F16F 9/516; F16F 9/535; F16F 2230/30

(57) ABSTRACT

An improved sealing assembly for a damper for use in a vehicle, and a damper including such an improved sealing assembly, is disclosed.

### FIELD OF THE DISCLOSURE

The present disclosure relates to the field of dampers (e.g., a shock absorber) for use in vehicle suspension systems, and more particularly to an improved sealing assembly for a damper or a damper containing an improved sealing assembly.

### BACKGROUND

Typical dampers typically include a chamber that is filled with fluids (e.g., hydraulic oil or magnetorheological fluid) which are configured to absorb compression forces during the damping process. However, some dampers may cease functioning if one or more seals of the sealing assembly are damaged or fail due to cyclic load experienced from compression, thus permitting fluids to leak around the sealing assembly.

The present inventive concepts address this and other shortcomings of the prior art devices.

### BRIEF DESCRIPTION OF THE DRAWINGS

The sealing assembly for a damper according to the present disclosure is further described with reference to the accompanying drawings, in which:

FIG. 1 is a side view of a damper according to the present disclosure;

FIG. 2 is cross-sectional view of the damper of FIG. 1 taken along the line labeled “2-2” of FIG. 1;

FIG. 3 is an enlarged, cross-sectional view of a portion of a sealing assembly and a piston of the damper labeled “3-3” in FIG. 2;

FIG. 4 is a perspective view of a sealing assembly according to the prior art;

FIG. 5 is a cross-sectional view of the sealing assembly of FIG. 4 according to the prior art, taken along the line labeled “5-5” of FIG. 4;

FIG. 6 is a perspective view of the sealing assembly of FIG. 3;

FIG. 7 is an enlarged, cross-sectional view of the area labeled “7-7” in FIG. 3, showing the sealing assembly according to the present disclosure;

FIG. 8 is an enlarged, cross-sectional view of a seal of the sealing assembly of FIG. 7, in a relaxed state; and

FIG. 9 is an enlarged, cross-sectional view of a seal of the sealing assembly of FIG. 7, in a pressurized state.

### SUMMARY OF THE INVENTIVE CONCEPTS

In one respect, the inventive concept is a sealing assembly for a damper, the sealing assembly comprising a housing, a bushing that is located within the housing, the bushing having a lateral surface, a seal located within the bushing, the seal having a medial sealing lip, a lateral sealing lip, and a space located between the medial sealing lip and the lateral sealing lip, wherein the lateral sealing lip is flexible to move between a first configuration in which it is not in contact with the lateral surface and a second configuration in which it contacts the lateral surface.

In another respect, the inventive concept is a damper comprising a cylinder housing including an opening, a piston located within the cylinder housing, a piston rod that is attached to the piston and that extends through the cylinder housing at the opening between a fully-contracted position that achieves a first pressure state within the cylinder housing and a fully-extended position that achieves a second pressure state within the cylinder housing, the second pressure state having a pressure value that is greater than the pressure value of the first pressure state, a sealing assembly that is located between the opening and the piston, the sealing assembly including a bushing having a lateral surface and a seal that is positioned between the piston rod and the bushing, the seal having a lateral sealing lip, wherein when the cylinder housing is in its first pressure state, the lateral sealing lip is in a relaxed configuration not in contact with the lateral surface of the bushing, and wherein when the cylinder housing is in its second pressure state, the lateral sealing lip is in a pressurized configuration in which it is pressed into contact with the lateral surface of the bushing.

### DETAILED DESCRIPTION

The ensuing detailed description provides exemplary example(s) only, and is not intended to limit the scope, applicability, or configuration of the herein disclosed example(s). Rather, the ensuing detailed description of the exemplary example(s) will provide those skilled in the art with an enabling description for implementing the exemplary examples in accordance with the present disclosure. It should be understood that various changes may be made in the function and arrangement of elements without departing from the spirit and scope of the invention, as set forth in the appended claims.

To aid in describing the disclosure and/or invention as claimed, directional terms may be used in the specification and claims to describe portions of the present disclosure and/or invention (e.g., upper, lower, left, right, etc.). These directional definitions are merely intended to assist in describing the example(s) and claiming the invention, and are not intended to limit the disclosure or claimed invention in any way. In addition, reference numerals that are introduced in the specification in association with a drawing figure may be repeated in one or more subsequent figures without additional description in the specification, in order to provide context for other features.

It should be understood that when an element is referred to as being “connected” or “coupled” to another element, it can be integral with the other element, directly connected or coupled to the other element, or that intervening elements may be present. In contrast, when an element is referred to as being “directly connected” or “directly coupled” to another element, it should be understood that no intervening elements are present. Other words used to describe the relationship between elements should be interpreted in a like fashion (e.g., “between” versus “directly between,” “adjacent” versus “directly adjacent,” etc.).

A suspension system for a vehicle often includes a damper (e.g., a shock absorber) and a spring to dampen or reduce impact of disturbances on a vehicle body during operation of the vehicle. For example, when the spring of the suspension is compressed (e.g., over a bump), the damper can absorb a cyclic load from a continual compression during piston operation and provide a smooth ride experience to a user. The damper can include one or more chambers that are filled with fluids (e.g., hydraulic oil or magnetorheological (MR) fluid) that can dissipate heat caused by the kinetic energy during the damping process. The damper can further include a sealing assembly to help retain the fluids within the chambers, thus maintaining a robust performance of the damper.

However, the damper can fail when the fluids leak from the sealing assembly and subsequently a housing (e.g., a strut) of the damper. In one example, the fluid leakage can occur when one or more seals of the sealing assembly are damaged over time. The seals may deteriorate due to cyclic temperature experienced during the damping process, for example heat from the friction between the piston and the seals or environmental temperature. Additionally, or alternatively, the cyclic load (e.g., fluid pressure) from compression and rebound strokes can progressively cause brittle, localized structural damage to the seals. This structural damage can impact overall performance of the suspension system and cause excessive movement of a vehicle's body and tires.

Accordingly, it is beneficial to have a sealing assembly for a damper with seals that can absorb the cyclic load and avoid blowout of seals, such that fluids are properly retained within the damper housing. Applicant has therefore developed examples of a sealing system comprising one or more seal(s) that includes a flexible sealing lip such that under high system pressure, the sealing lip flushes against a portion of the sealing assembly (e.g., a bushing or a seal housing) to create a cavity in which the fluids can reside under pressure that is significantly lower than the system pressure, thus preventing the fluids from blowing past the seal and subsequently the damper housing. Various geometries and arrangements of the seals will be described below.

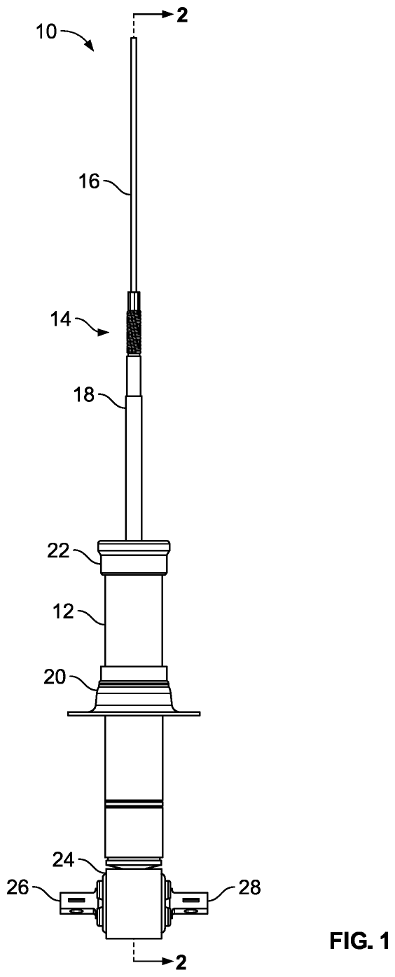

Referring now to FIGS. 1-3, one example of a damper 10 of a suspension system according to the present disclosure will be described in detail. In this example, the damper 10 comprises a piston rod 14, a cylinder housing 12, and a mount 24. In this example, the piston rod 14 includes an inner piston rod 16 and an outer piston rod 18. The piston rod 14 can move approximately vertically relative to the cylinder housing 12 to move between an extended position (e.g., to achieve a rebound stroke) and a contracted position (e.g., to achieve a compression stroke). Pressure within the damper 10 is typically higher in the contracted position than the extended position. A top portion of the cylinder housing 12 is at least partially covered with a cap 22. The damper 10 can further include a seat 20. In this example, the cylinder housing 12 is sized to receive a spring (not shown) of the suspension system therearound, with the spring resting on the seat 20. In this example, the mount 24 includes two eyelets 26, 28 on respective sides thereof so that the damper 10 can be mounted or connected to other parts of a vehicle (e.g., a vehicle frame or a transmission system).

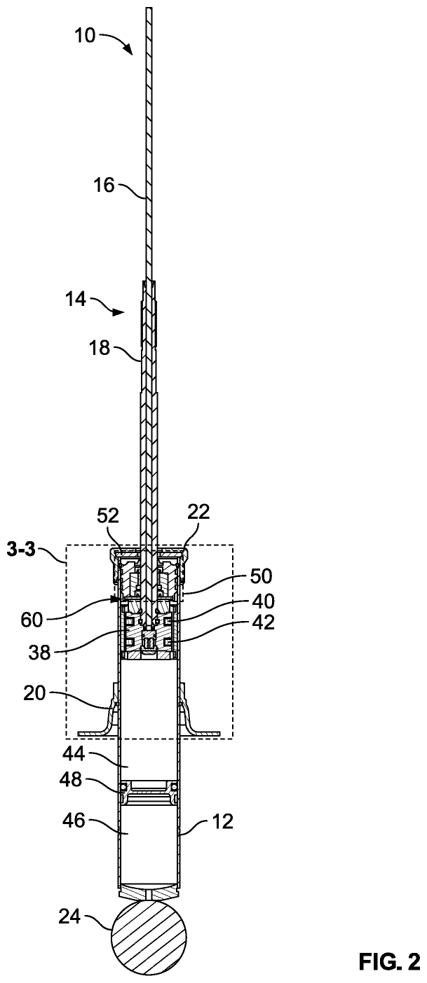

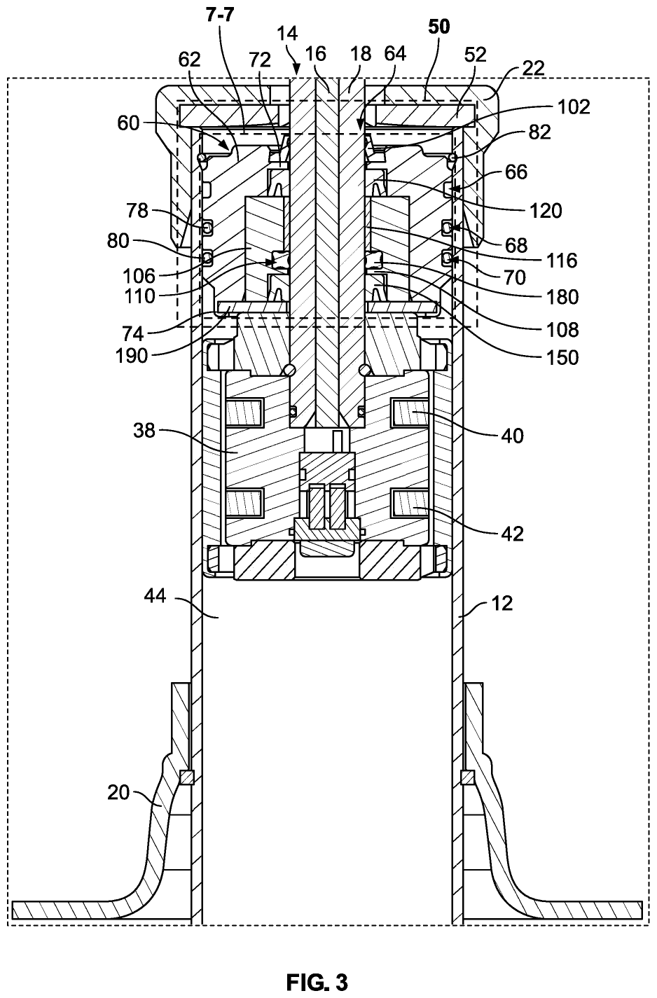

As best shown in FIGS. 2 and 3, the damper 10 further comprises a piston 38 that can move vertically across the cylinder housing 12 during a damping process. In this embodiment, the piston 38 is attached to the piston rod 14 and positioned within the cylinder housing 12. In this example, the cylinder housing 12 includes a diaphragm 48 that separates the cylinder housing 12 into a chamber 44 and an accumulator 46. In one example, the chamber 44 is adapted to contain damper fluids (e.g., hydraulic oil or MR fluids) and the accumulator 46 is adapted to contain compressed gas. In embodiments in which the damper 10 is a magnetic ride damper, the piston 38 can include coils 40, 42 that are configured to generate electric current to magnetize the fluids (i.e., MR fluids) to change the viscosity of those fluids during operation. While not shown, the damper 10 can—in some examples—also include an electronic control unit (ECU) and various sensors to adaptively change the fluid viscosity.

In this example, the damper 10 has a rod sealing assembly 50 that includes a disk 52 and a sealing assembly 60. The rod sealing assembly 50 is positioned approximately toward an upper portion of the cylinder housing 12 to enhance the sealing mechanism of the damper 10. In the present example, the disk 52 is located on the cylinder housing 12 and is adapted to fit (e.g., pressure fit) into the cap 22 to close the cylinder housing 12. Further, the disk 52 is approximately cylindrical. While not shown, the disk 52 has top and bottom surfaces, each having grooves. In alternate examples, the disk 52 can have top and bottom surfaces with flat surfaces and/or may not be cylindrically shaped.

In the present embodiment, the sealing assembly 60 is located within the cylinder housing 12 and below the disk 52. The sealing assembly 60 is located above the piston 38 such that when the piston rod 14 is in the extended position, the piston 38 contacts the sealing assembly 60 as shown in FIGS. 2 and 3. When the piston rod 14 is in the contracted position, the piston 38 may be positioned toward a lower part of the chamber 44. Thus, vertical movement of the piston 38 can be limited within the chamber 44, achieving various pressure states between compression and rebound strokes of the damper 10.

Referring to FIG. 3 specifically, the sealing assembly 60 includes a seal housing 62 that is adapted to accommodate various rings and seals. Some mechanical parts can be arranged on an exterior of the seal housing 62 to hold the sealing assembly 60 in place. For example, the seal housing 62 has three grooves 66, 68, 70. The grooves 68, 70 each receive, respectively, one of two static seals 78, 80. The static seals 78, 80 allow a tight fitting of the sealing assembly 60 within the chamber 44, for example, to prevent the sealing assembly 60 from freely sliding downward. Further, a ring 82 can be placed toward top of the seal housing 62 to limit the sealing assembly 60 from sliding upwardly past the ring 82.

In this example, the seal housing 62 is shaped and sized to retain mechanical fasteners and seals to prevent damper fluids from leaking through the sealing assembly 60. In this embodiment, the seal housing 62 has a protrusion 72 toward an upper end of the seal housing 62 and a hook 74 toward a bottom end of the seal housing 62. A wiper seal 102 can be positioned on the protrusion 72 and adapted to wipe off any lubricants on the piston rod 14 to prevent the lubricants from entering the chamber 44 and being mixed with the damper fluids. The hook 74 can retain a plate 190 (e.g., a bottom cap) within the seal housing 62, and the plate 190 can define a bottom surface of the sealing assembly 60. The sealing assembly 60 further includes a bushing 106 that is located above the plate 190. The bushing 106 is shaped such that the bushing 106 can receive and engage with seals 120, 150, 180. For example, the bushing 106 has a recess 110 that is formed above a ledge 108 and sized to receive the seal 180. The ledge 108 and the plate 190 are spaced apart such that the seal 180 is positioned therebetween. Further, the seal 120 is positioned above the bushing 106 and below the protrusion 72. The sealing assembly 60 includes a guide ring 116 that is sized to concentrically fit within the bushing 106 and adapted to guide movement of the piston rod 14. The guide ring 116 can be positioned above the seal 180. In this embodiment the guide ring 116 is made with polytetrafluoroethylene, but other materials are possible.

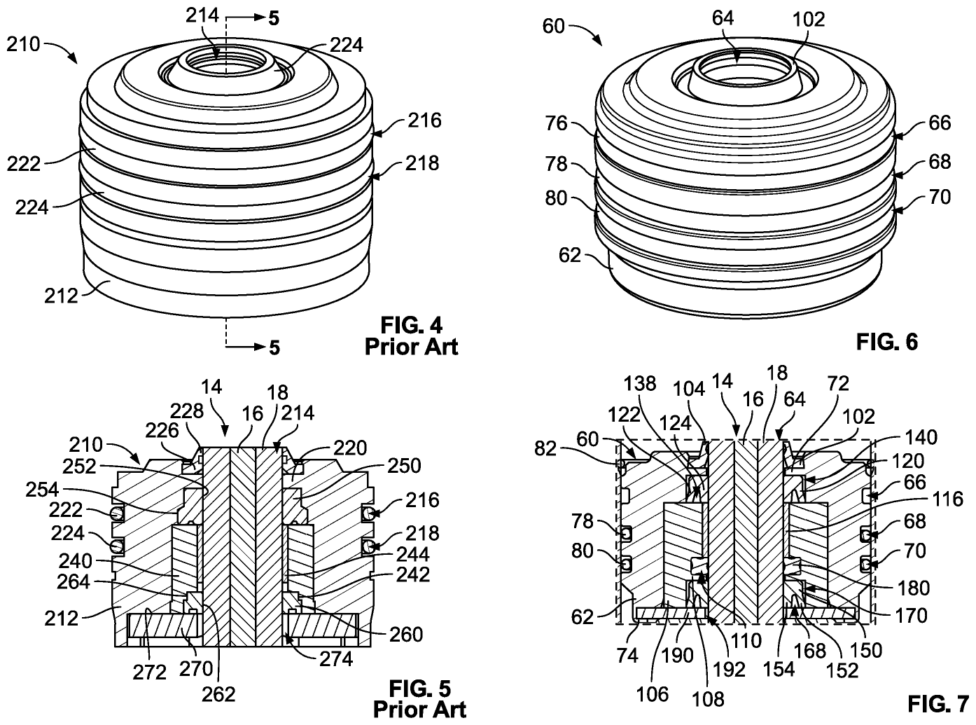

Referring now to FIGS. 4 and 5, one example of a conventional sealing assembly 210 according to the prior art is illustrated. In this example, the sealing assembly 210 includes a seal housing 212 that is shaped and sized to accommodate various seals and mechanical fasteners. The sealing assembly 210 has an opening 214 that the piston rod 14 can extend through. The piston rod 14 includes the inner piston rod 16 and the outer piston rod 18. An exterior of the seal housing has grooves 216, 218 that are sized to receive static seals 222, 224, respectively. The seal housing 212 includes a protrusion 220 that can receive a wiper seal 226 thereon. The wiper seal 226 includes a wiper seal lip 228 that engages with the piston rod 14. The sealing assembly 210 further includes a plate 270 that defines a bottom surface of the sealing assembly 210. The plate 270 has a surface 272 that is flushed against the seal housing 212. An inner diameter of the plate 270 is larger than an outer diameter of the piston rod 14, such that a clearance 274 is formed between the plate 270 and the piston rod 14. During damping, fluids can enter the sealing assembly 210 through the clearance 274.

In one example, the sealing assembly 210 includes a bushing 240 that is located above the plate 270. The bushing 240 is shaped such that the bushing 240 can receive and engage with seals 250, 260. For example, the bushing 240 includes a ledge 242 that is shaped to hold the seal 260 in place. An outer surface 264 of the seal 260 approximately matches the shape of the ledge 242. The seal 250 is located on top of the bushing 240, and an outer surface 254 of the seal 250 approximately matches a shape of the seal housing 212. The sealing assembly 210 includes a guide ring 244 that is sized to concentrically fit within the bushing 240 and adapted to guide movement of the piston rod 14. The seals 250, 260 has inner surfaces 252, 262, respectively, that are rigidly in contact with the piston rod 14.

In some implementations, the geometry and arrangement of the seals 250, 260 can cause fluid leakage of a damper (not shown) that includes the sealing assembly 210. For example, a chamber (not shown) of the damper can become pressurized during the damping process, forcing the fluids to flow into the sealing assembly 210 through the clearance 274. As the fluids are pushed up against the seal 260, the seal 260 correspondingly becomes flushed against the bushing 240. Because the seal 260 is relatively rigid and its geometry does not provide any flexibility, the seal 260 is fixed in position and shape during the damping process. Thus, the fluids do not have any spaces or cavities to reside within the sealing assembly 210, and this can lead to eventual blowout of the seal 260 under high system pressure. The fluids can continue to flow through the rest of the sealing assembly 210, including around the seal 250, and ultimately leak out of a housing (not shown) of the damper. Therefore, the sealing assembly 210 is prone to failure as the seals 250, 260 do not provide any space for the fluids to reside within the sealing assembly 210 at a relatively low pressure without being forced out of the sealing assembly 210.

In contrast, the sealing assembly 60 according to the present disclosure can prevent fluid leakage of the damper 10 by providing flexible seals that can actively retain fluids within the cylinder housing 12 (e.g., strut). Referring now to FIGS. 6-9, the sealing assembly 60 will be discussed in detail. As generally described above, the sealing assembly 60 includes a seal housing 62 that is shaped and sized to engage with various seals and mechanical fasteners. The sealing assembly 60 has an opening 64 at which the piston rod 14 is adapted to extend through the cylinder housing 12. An exterior of the seal housing has grooves 66, 68, 70. The grooves 68, 70 are each sized to receive a respective one of the static seals 78, 80. The seal housing 62 includes a protrusion 72 that can receive a wiper seal 102 thereon. The wiper seal 102 includes a wiper seal lip 104 that moves across an outer surface of the outer piston rod 18 to limit piston rod lubricants from entering the chamber 44. The sealing assembly 60 further includes a plate 190 that is retained within the seal housing 62 via the hook 74 and defines a bottom surface of the sealing assembly 60. An inner diameter of the plate 190 is larger than an outer diameter of the piston rod 14, such that a clearance 192 is formed between the plate 190 and the piston rod 14. The sealing assembly 60 includes the bushing 106 and the guide ring 116 that are concentrically aligned and adapted to allow the piston rod 14 to extend therethrough.

The sealing assembly 60 further comprises the seals 120, 150, 180. As shown in FIG. 7, the seal 120 is positioned between the bushing 106 and the protrusion 72. The seal 120 includes a lower portion that is approximately “U”- or “V”-shaped in cross-section, with a lower portion comprising a lateral sealing lip 122 and a medial sealing lip 124. The lateral sealing lip 122 is approximately angled toward the seal housing 62. In this example, a cavity 140 is formed between the seal 120 and the seal housing 62, and a space 138 is formed between the seal 120 and the bushing 106, in particular between the lateral sealing lip 122 and the medial sealing lip 124. The lateral sealing lip 122 and the medial sealing lip 124 can each flexibly move approximately laterally such that a volume of the space 138 changes (i.e., increases or decreases). For example, the medial sealing lip 124 can flex toward the space 138 when the piston rod 14 is inserted through the sealing assembly 60. As will be discussed in detail below, the lateral sealing lip 122 can actively flex toward the seal housing 62 (i.e., away from the piston rod 14) when the system pressure within the chamber 44 increases.

Generally similar to the seal 120, the seal 150 includes a lower portion that is approximately “U”- or “V”-shaped in cross-section and that includes a lateral sealing lip 152 and a medial sealing lip 154. The seal 150 is positioned between the bushing 106 and the protrusion 72. The lateral sealing lip 152 is approximately angled toward the bushing 106. In this example, a cavity 170 is formed between the seal 150 and the bushing 106, and a space 168 is formed between the seal 150 and the plate 190, in particular between the lateral sealing lip 152 and the medial sealing lip 154. The lateral sealing lip 152 and the medial sealing lip 154 can each flexibly move approximately laterally such that a volume of the space 168 changes (i.e., increases or decreases). For example, the medial sealing lip 154 can flex toward the space 168 when the piston rod 14 is inserted through the sealing assembly 60. As will be discussed in detail below, the lateral sealing lip 152 can actively flex toward the bushing 106 (i.e., away from the piston rod 14) when the system pressure within the chamber 44 increases. Overall shapes of the seals 120, 150 are substantially the same in this example, but the shapes including geometries and sizes of the seals 120, 150 may be different in alternate examples.

In the present example, the seal 180 is approximately “X”-shaped in cross-section and has four corners (i.e., lobes) that are each bulbous. The seal 180 may have an approximately square cross-sectional shape with four sides that each include a concave curve. In this example, the seal 180 is an X-ring, which may be beneficial in dynamic applications (in which the seal is constantly moving against another part) to help extend the lifespan of the seal 180. In particular, due to a relatively low coefficient of friction of the seal 180 designed in this fashion, there may be a relatively low frictional force between the seal 180 and the piston rod 14 while the piston rod 14 is repeatedly moving between the extended position and the contracted position. Further, such a geometry for the seal 180 may permit some lubricant to be retained within the concave curve of the seal 180 and then move past the seal 180, which helps lubricate the seal 120 and the wiper seal 102, thus prolonging their service lives. Further, it may be beneficial to have one or more seals between the seals 120, 150 to aid in absorbing system pressure or blocking fluids from travelling through the sealing assembly 60. In particular, the seal 180 can help alleviate an intermediate pressure between the seals 150, 180 when the system pressure decreases below the intermediate pressure, thereby preventing a pressure trap within the sealing assembly 60.

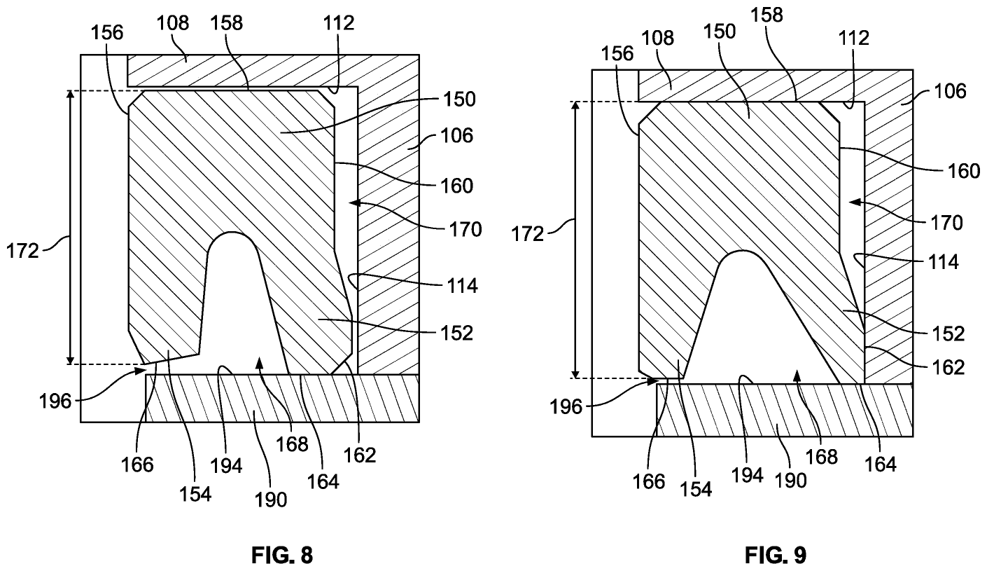

Referring to FIGS. 8 and 9, the seal 150 will be described in greater detail. While FIGS. 8 and 9 show a cross-section of the seal 150, it should be understood that similar geometric and functional descriptions generally also apply to the seal 120. As best shown in FIGS. 8 and 9, the seal 150 is defined by a height 172, an inner (medial) surface 156 that is adapted to contact the outer piston rod 18, an outer (lateral) surface 159, and a top surface 158 that is adapted to contact a ledge surface 112 of the bushing 106. In particular, the seal 150 has an upper portion that is approximately rectangular shaped (e.g., a solid block) with chamfered corners and is at least defined by an upper lateral surface 160. The seal 150 further comprises a lower portion that includes the lateral sealing lip 152 and the medial sealing lip 154. The lateral sealing lip 152 is at least defined by a lower lateral surface 162 and a lateral bottom surface 164. The medial sealing lip 154 is at least defined by a medial bottom surface 166. The lateral bottom surface 164 and the medial bottom surface 166 are each adapted to contact a plate surface 194 of the plate 190. In this example, a height of the upper portion of the seal 150 is approximately the same as a height of the lower portion thereof. In alternate examples, the height of the upper portion may be different (i.e., taller or shorter) than the height of the lower portion, as long as structural integrity of the seal 150 can be maintained while allowing for suitable flexibility of the sealing lips of the lower portion. While some corners of the seal 150 in this embodiment are chamfered, the corners need not be chamfered and can be differently shaped (e.g., rounded, filleted, sharp, etc.).

With specific reference to FIG. 8, a cross-section of the seal 150 in a relaxed configuration is illustrated. In this state, the damper 10 may be on a compression stroke or a rebound stroke but not at its maximum system pressure. The piston rod 14 may be fully extended (i.e., at a bottom of the chamber 44) or partially extended. In this configuration, the lateral bottom surface 164 is in contact with the plate surface 194. A gap 196 can form between the medial bottom surface 166 and the plate surface 194, allowing for some fluids to flow into the space 168 that is formed between the seal 150 and the plate 190. In this example, the space 168 is defined between the lateral sealing lip 152 and the medial sealing lip 154. As the lateral sealing lip 152 and the medial sealing lip 154 are separated, the lateral sealing lip 152 and the medial sealing lip 154 can move independently from one another. In the relaxed configuration, the lower lateral surface 162 is not fully flushed against a lateral surface 114 (i.e., circumferential surface) of the bushing 106. The top surface 158 of the seal 150 may not be fully in contact with the ledge surface 112. The cavity 170 is formed between the seal 150 (in particular the lateral side 159 thereof) and the bushing 106 and adapted to retain some fluids.

FIG. 9 illustrates a cross-section of the seal 150 in a pressurized configuration. In this state, the damper 10 may be on a compression stroke at its maximum system pressure or a rebound stroke at its maximum system pressure. Put differently, the piston rod 14 may be in a fully contracted position. In one example, the damper 10 is subjected to absorbing energy due to a high impact force on the suspension system. System pressure of the damper 10 can increase subsequently during damping, and the sealing assembly 60 can be subject to absorbing the elevated (i.e., spiked) pressure. As the fluids within the chamber 44 are forced to move due to the elevated pressure, the seal 150 can move from the relaxed configuration (shown in FIG. 8) to the pressurized configuration that seals the cavity 170, thereby creating a pressure trap. By storing the fluids within the sealing assembly 60 that are in a pressurized state, i.e., an intermediate pressure that is lower than the maximum system pressure, the likelihood of deformation of the seal 150 is decreased. Accordingly, fluid leakage out of the sealing assembly 60 can be prevented. When the system pressure decreases below the intermediate pressure, the intermediate pressure between the seal 150 and the seal 180 (shown in FIG. 7) is vented, the seal 150 relaxes again (back to its configuration shown in FIG. 8), and the fluids that had been trapped within the sealing assembly 60 can flow back down to the chamber 44.

In the present example, when the system pressure approaches the maximum value, the lateral sealing lip 152 can quickly flex in a lateral direction toward the bushing 106 and form the cavity 170 between the seal 150 and the bushing 106. In this example, the lateral bottom surface 164 is in contact with the plate surface 194 and the lower lateral surface 162 is flushed against the lateral surface 114, thus sealing the bottom side of the cavity 170. The upper lateral surface 160 of the seal 150 is spaced apart from the lateral surface 114 of the bushing 106 to form the cavity 170. The top surface 158 of the seal 150 contacts the ledge surface 112 to seal off the top side of the cavity 170. The gap 196 may exist between the medial bottom surface 166 and the plate surface 194, and some fluids that are pressed into the space 168 during damping may reside therewithin. However, since the cavity 170 is now an enclosed space, the fluids may be trapped within the cavity 170 until the maximum system pressure of the damper 10 is relieved. When the system pressure decreases, the lateral sealing lip 152 flexes back medially to the relaxed configuration (shown in FIG. 8), allowing the fluids to travel past the seal 150, through the clearance 192, and back into the chamber 44. Additionally, the present seal design can also prevent air from entering the cylinder housing 12, which can subsequently cause cavitation of the fluids and system failure.

In the event that fluids do travel upward past the cavity 170, the seals 120, 180 (shown in FIG. 7) can additionally contribute to preventing fluid leakage from the sealing assembly 60. In this embodiment, the seal 180 is located above the seal 150 and may act as a backup to retard the progress of any fluid that leaks above the seal 150. In this example, the seal 120 may function substantially similarly to the seal 150 as described herein. While some features of the seal 120 are not labeled herein for brevity, a general description of the features and functionality of the seal 150 equally applies to the seal 120. For example, under high damper system pressure, the lateral sealing lip 122 can quickly flex in a lateral direction toward the seal housing 62 and form the cavity 140 between the seal 150 and the seal housing 62. A lateral bottom surface (not labeled) may contact a top surface (not labeled) of the bushing 106, and the lower lateral surface (not labeled) may contact an inner surface (not labeled) of the seal housing 62. An upper lateral surface (not labeled) faces and helps form the cavity 140. The top surface contacts the protrusion 72 of the seal housing 62 to seal off the cavity 140. A gap (not shown) may exist between the medial bottom surface and the guide ring 116, and some fluids that are pressed into the space 138 may reside therewithin during damping. Since, in a pressurized configuration, the cavity 170 is an enclosed space, the fluids may be trapped within the cavity 170 until the high system pressure of the damper 10 is relieved. When the system pressure decreases, the lateral sealing lip 122 can flex back medially to achieve the relaxed configuration, and the fluids can travel back down into the chamber 44.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as examples of the invention, of the utilized features and implemented capabilities of such device or system.

As used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

Although exemplary implementations of the herein described systems and methods have been described in detail above, those skilled in the art will readily appreciate that many additional modifications are possible in the exemplary examples without materially departing from the novel teachings and advantages of the herein described systems and methods. Accordingly, these and all such modifications are intended to be included within the scope of the herein described systems and methods. The herein described systems and methods may be better defined by the following exemplary claims.

What is claimed is:

1. A sealing assembly for a damper, the sealing assembly comprising:
a housing;
a bushing that is located within the housing, the bushing having a lateral surface;
a seal located within the bushing, the seal having a medial sealing lip, a lateral sealing lip, and a space located between the medial sealing lip and the lateral sealing lip,
wherein the lateral sealing lip is flexible to move between a first configuration in which it is not in contact with the lateral surface and a second configuration in which it contacts the lateral surface.

2. The sealing assembly of claim 1, wherein when the lateral sealing lip is in its second configuration, a cavity is formed between a lateral side of the seal and the bushing.

3. The sealing assembly of claim 1, further comprising a plate that is placed within the housing and defines a bottom surface of the sealing assembly, the seal being located between the plate and the bushing.

4. The sealing assembly of claim 3, wherein the lateral sealing lip includes a lower lateral surface and a lateral bottom surface, the lower lateral surface contacting the lateral surface of the bushing and the lateral bottom surface contacting the plate in the second configuration.

5. The sealing assembly of claim 2, wherein the seal further includes an upper lateral surface that faces and helps forms the cavity.

6. The sealing assembly of claim 1, wherein the medial sealing lip, the lateral sealing lip, and the space together form an approximate “U” or “V” shape in cross-section.

7. The sealing assembly of claim 1, wherein the medial sealing lip is able to move independently of the lateral sealing lip when the lateral sealing lip moves between the first configuration and the second configuration.

8. The sealing assembly of claim 1, wherein the sealing assembly further includes a second seal that is located above the seal, the second seal having a second medial sealing lip, a second lateral sealing lip, and a second space located between the second medial sealing lip and the second lateral sealing lip.

9. The sealing assembly of claim 8, further comprising a seal housing that contains the second seal, the seal housing having a second lateral surface, wherein the second lateral sealing lip is flexible to move between a first configuration in which it is not in contact with the second lateral surface and a second configuration in which it is in contact with the second lateral surface.

10. The sealing assembly of claim 9, wherein the sealing assembly further includes a third seal that is located above the first seal.

11. The sealing assembly of claim 10, wherein the third seal has an approximately “X”-shaped cross-section.

12. A damper comprising:
a cylinder housing including an opening;
a piston located within the cylinder housing;
a piston rod that is attached to the piston and that extends through the cylinder housing at the opening between a fully-contracted position that achieves a first pressure state within the cylinder housing and a fully-extended position that achieves a second pressure state within the cylinder housing, the second pressure state having a pressure value that is greater than the pressure value of the first pressure state; and
a sealing assembly that is located between the opening and the piston, the sealing assembly including a bushing having a lateral surface and a seal that is positioned between the piston rod and the bushing, the seal having a lateral sealing lip,
wherein when the cylinder housing is in its first pressure state, the lateral sealing lip is in a relaxed configuration not in contact with the lateral surface of the bushing, and wherein when the cylinder housing is in its second pressure state, the lateral sealing lip is in a pressurized configuration in which it is pressed into contact with the lateral surface of the bushing.

13. The damper of claim 12, the lateral sealing lip further comprising a lower lateral surface, wherein the lower lateral surface contacts the lateral surface of the bushing when the lateral sealing lip is in its pressurized configuration.

14. The damper of claim 12, the seal further comprising a lateral surface, the seal forming a cavity between the lateral surface thereof and the lateral surface of the bushing when the lateral sealing lip is in its pressurized configuration.

15. The damper of claim 14, wherein the cylinder housing further includes a chamber that is filled with fluid, the cavity being adapted to contain some portion of the volume of the fluid when the cylinder housing is in its second pressure state.

16. The damper of claim 15, wherein the remaining volume of the fluid is retained within the cylinder housing during operation of the damper.

17. The damper of claim 15, wherein the fluid is a magnetorheological fluid.

18. The damper of claim 12, wherein the seal further includes a top surface and the bushing further comprises a ledge surface, wherein the top surface is not in contact with the ledge surface when the cylinder housing is in its first pressure state, and wherein the top surface is in contact with the ledge surface when the cylinder housing is in its second pressure state.

19. The damper of claim 12, wherein the sealing assembly further includes a seal housing and a second seal that is located above the bushing, the second seal having a second lateral sealing lip, the second lateral sealing lip flexibly moving toward the seal housing to form a second cavity between the second seal and the seal housing when the cylinder housing is in its first pressure state.

20. The damper of claim 19, wherein the sealing assembly further includes a third seal that is positioned between the first seal and the second seal.
